(19) United States
(12) Patent Application Publication
(10) Pub. No.: US 2024/0088369 A1
(43) Pub. Date: Mar. 14, 2024

(54) MICROCOMPOSITE ALLOY STRUCTURE

(71) Applicant: 6K Inc., North Andover, MA (US)

(72) Inventors: Richard K. Holman, Wellesley, MA (US); Leah Nation, Cambridge, MA (US)

(21) Appl. No.: 18/509,166

(22) Filed: Nov. 14, 2023

Related U.S. Application Data
(63) Continuation of application No. 17/304,727, filed on Jun. 24, 2021, now Pat. No. 11,855,278.
(60) Provisional application No. 63/043,958, filed on Jun. 25, 2020.

(51) Int. Cl. H01M 4/38; H01M 10/0525

(52) U.S. Cl. CPC H01M 4/386; H01M 10/0525; H01M 2004/021

(57) ABSTRACT

Disclosed herein are embodiments of strain tolerant particles, methods of manufacturing such structures, and feedstock to form said structures. In some embodiments, the structures can include alternating regions of an energy storage structure and a reinforcing structure. Advantageously, when the strain tolerant particles are used within an anode of a lithium ion battery, the reinforcing structure may provide mechanical stability to the particles and thus increase cycle life.

### REFERENCE TO RELATED APPLICATIONS

This application is a continuation of U.S. application Ser. No. 17/304,727, filed Jun. 24, 2021, which claims the priority benefit under 35 U.S.C. § 119(e) of U.S. Provisional Application No. 63/043,958, filed Jun. 25, 2020, the entire disclosure of which is incorporated herein by reference.

### BACKGROUND

### Field

The present disclosure is generally directed in some embodiments towards powders, structures, precursors, and methods of manufacturing said powders and structures to form strain tolerant materials.

### Description of the Related Art

Alloy-type anode materials, which include Si, Si alloys, SiO, and Sn alloys, have been an area of intense research for over 20 years. An advantage to this class of materials is a large increase in lithium (Li) storage capacity, or simply capacity, over conventional anode materials based on carbon (primarily graphite), as much as 10× in the case of Si compared to typical commercial graphite anodes. However, their adoption as a full replacement for graphite has been impeded by very poor cycle life. Silicon (Si) undergoes a 300% volume increase upon full lithiation, and 300% decrease upon subsequent delithiation. This massive volume cycling results in mechanical damage to the Si particles, which results in material disconnection, fresh surfaces that react with the electrolyte and consume lithium while passivating, and thus capacity loss and impedance growth, in as few as a few cycles in the worst case. As a result, alloy anodes have been limited commercially to blends of very fine alloy particles with graphite, generally at <10% of the total active material.

### SUMMARY

Disclosed herein are embodiments of a strain tolerant particle comprising a composite structure including an energy storage structure (or phase) comprising at least one element, wherein the energy storage structure is configured to store ions, and a reinforcing structure (or phase) comprising one or more elements that phase separate from the energy storage phase. This phase separation can be via a eutectic or eutectoid reaction, wherein the reinforcing structure provides mechanical support to the energy storage structure.

In some embodiments, the energy storage structure comprises silicon and/or tin. In some embodiments, the reinforcing structure comprises nickel, copper, iron, aluminum, magnesium, manganese, cobalt, molybdenum, zirconium, vanadium, titanium, chromium, bismuth, antimony, germanium, boron, phosphorus, carbon, sulfur, nitrogen, and/or oxygen. In some embodiments, the energy storage structure comprises silicon and the reinforcing structure comprises an intermetallic compound including nickel and silicon. In some embodiments, the intermetallic compound comprises NiSi₂ and NiSi. In some embodiments, the reinforcing structure comprises a higher nickel content than the nickel content of the energy storage structure.

In some embodiments, the composite structure comprises a silicon mole fraction greater than or equal to about 0.56. In some embodiments, the composite structure comprises a silicon mole fraction greater than or equal to about 0.7.

In some embodiments, the energy storage structure comprises silicon and the reinforcing structure comprises an intermetallic compound including copper and silicon. In some embodiments, the intermetallic compound comprises Cu₁₉Si₆. In some embodiments, the reinforcing structure comprises a higher copper content than the copper content of the energy storage structure.

In some embodiments, the composite structure comprises a plurality of energy storage structures and a plurality of reinforcing structures which bind the plurality of energy storage structures.

In some embodiments, the composite structure comprises a silicon mole fraction greater than or equal to about 0.24. In some embodiments, the composite structure comprises a silicon mole fraction greater than or equal to about 0.32.

Also disclosed herein are embodiments of a method of manufacturing a strain tolerant particle comprising preparing a feedstock comprising finely divided droplets or particles with a certain ratio of constituent elements that phase separate into two or more phases by eutectic or eutectoid reaction, introducing the feedstock into a plasma or plasma exhaust of a microwave plasma torch to melt the feedstock, and cooling the feedstock in a rapid but controlled manner so as to trigger a eutectic or eutectoid transition resulting in one or more phase separations which create a composite structure comprising an energy storage structure and a reinforcing structure that provides mechanical support to the energy storage structure.

In some embodiments, the feedstock comprises silicon and at least one of copper, nickel, or iron. In some embodiments, the feedstock comprises copper and comprises a silicon mole fraction greater than or equal to about 0.24. In some embodiments, the feedstock comprises copper and comprises a silicon mole fraction greater than or equal to about 0.32. In some embodiments, the feedstock comprises nickel and comprises a silicon mole fraction greater than or equal to about 0.56. In some embodiments, the feedstock comprises nickel and comprises a silicon mole fraction greater than or equal to about 0.7.

Also disclosed herein are embodiments of an anode of a lithium ion battery comprising a plurality of strain tolerant particles comprising an in-situ formed composite structure comprising a plurality of energy storage structures and reinforcing structures, wherein the energy storage phase comprises substantially silicon, and wherein the reinforcing structure comprises an element or elements that phase separate into two or more phases with silicon by eutectic or eutectoid reaction.

In some embodiments, the element comprises at least one of nickel, copper, or iron.

Also disclosed herein are embodiments of a strain tolerant particle comprising a composite structure including an energy storage phase comprising at least one element, wherein the energy storage phase is configured to store ions and a reinforcing phase comprising one or more elements, where upon cooling from the melt a eutectic or eutectoid transition occurs resulting in phase separation into two or more distinct phases, at least 1 of which is an energy storage phase, and at least one of which is a reinforcing phase, resulting in an in-situ grown composite microstructure at the particle level, wherein the reinforcing phase or phases provide mechanical support to the energy storage phase or phases.

Further embodiments are directed to a particle as disclosed herein.

Further embodiments are directed to a powder as disclosed herein.

Further embodiments are directed to a method of manufacturing a particle as disclosed herein.

### BRIEF DESCRIPTION OF THE DRAWINGS

FIG. 1A is a scanning electron microscopy (SEM) image of an exemplary strain tolerant particle according to the present disclosure.

FIG. 1B is an energy-dispersive X-ray Spectroscopy (EDS) element composition map showing regions of high concentrations of silicon (Si) of the particle of FIG. 1A.

FIG. 1C is an EDS element composition map showing regions of high concentrations of nickel (Ni) of the particle of FIG. 1A.

FIG. 2A is an image of an exemplary strain tolerant particle composed of a eutectic or eutectoid composition of silicon and nickel.

FIG. 2B is an image of an exemplary strain tolerant particle composed of a eutectic or eutectoid composition of silicon and nickel.

FIG. 3 is an image of an exemplary strain tolerant particle composed of hypereutectic composition of silicon and copper.

FIG. 4 is a chart of capacity vs voltage of an example anode of a lithium ion battery using strain tolerant particles according to the present disclosure.

FIG. 5 illustrates an example embodiment of a method of producing powders according to the present disclosure.

FIG. 6 illustrates an embodiment of a microwave plasma torch that can be used in the production of powders, according to embodiments of the present disclosure.

FIGS. 7A-7B illustrate embodiments of a microwave plasma torch that can be used in the production of powders, according to a side feeding hopper embodiment of the present disclosure.

### DETAILED DESCRIPTION

Disclosed herein are embodiments of methods, powders/particles, structures, feedstocks, and precursors for forming strain tolerant materials, and devices which incorporate said materials. The materials can be powders of a specific particle level composite structure for a strain-tolerant alloy-type anode. The strain-tolerant alloy-type anode can include strain tolerant particles, which can include a structure capable of withstanding the strain created from energy storage and thus prevent the particles from breaking up.

In some embodiments, the particle level composite structure can include both an energy storage structure (e.g. phase, chemistry, formulation, configuration, framework) and a reinforcing structure (e.g. phase, chemistry, formulation, configuration, framework). In some embodiments, the particle may include alternating regions of the energy storage structure and the reinforcing structure. The reinforcing phase may have some energy storage capacity.

The feature size of the composite structures may be on the order of micron scale to nano-scale. As disclosed herein, the powders can be formed by processing certain feedstock materials in a microwave plasma torch, or other processing method. The processing can include feeding the feedstock into a microwave plasma torch, a plasma plume of the microwave plasma torch, and/or an exhaust of the microwave plasma torch. The location may vary depending on the type of feedstock used. Further the feedstock can be produced or selected based on different requirements. Examples of requirements are aspect ratio, particle size distribution (PSD), chemistry, density, diameter, sphericity, oxygenation, and pore size. The processing can further include cooling the processed feedstock through a controlled cooling rate. It has been discovered that a higher cooling rate results in finer structures.

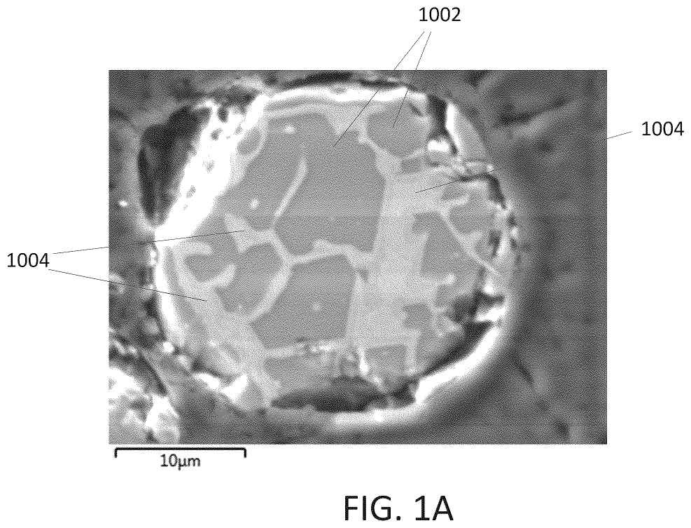

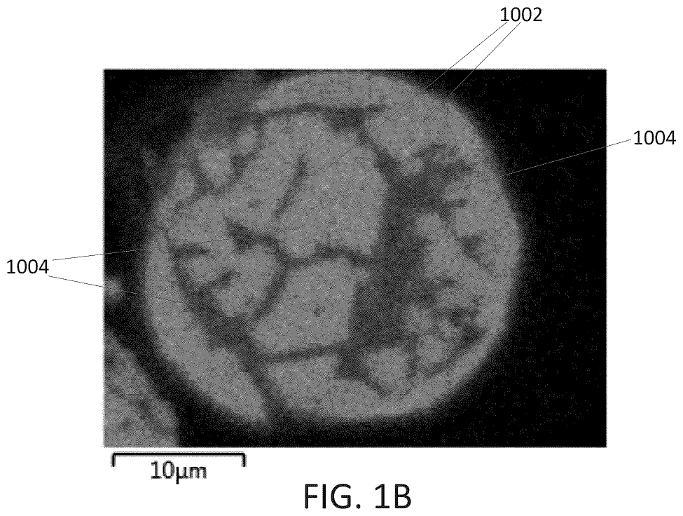

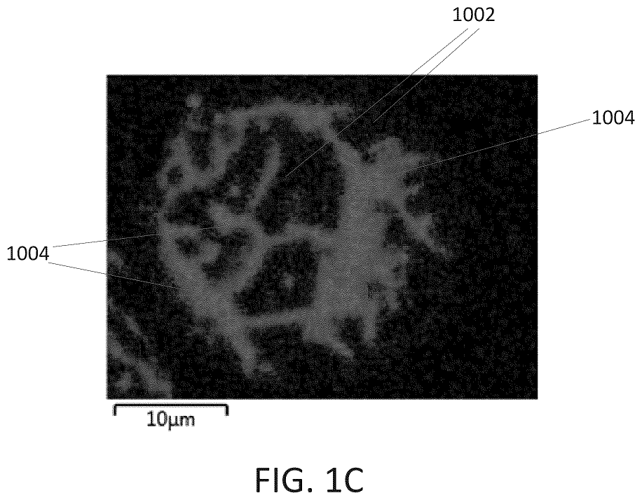

An example of a particle of an exemplary powder is shown in FIGS. 1A-1C. FIG. 1A illustrates a scanning electron microscope (SEM) image of the particle. FIG. 1B illustrates an energy-dispersive X-ray Spectroscopy (EDS) element composition map using a specific imaging source to show regions of high concentrations of silicon (Si) of the particle of FIG. 1A. FIG. 1C illustrates an EDS element composition map using a specific imaging source to show regions of high concentrations of nickel (Ni). The particle contains in-situ formed composite alloy structures. When used in a battery, the high concentrations of Si regions make up an energy storage structure while the high concentration of Ni regions make up a reinforcing structure.

The energy storage structure stores charged ions while the reinforcing structure functions primarily as a high strength structural member to prevent particle breakup due to the large expansion of the energy storage structure when storing energy. The reinforcing structure 1004 also provides resistance to expansion by acting as a diluent phase, which reduces the overall expansion of the particle in a controlled way. The reinforcing structure 1004 further acts as an electronic conductor to provide a low resistance path for electrons to enter and leave the particle. As illustrated, there is alternating regions of energy storage structure 1002 and reinforcing structure 1004.

In some embodiments, the energy storage structure 1002 may include Si, Si alloys such as silicon oxide (SiO), tin (Sn), or Sn alloys such as tin oxide (SnO). In some embodiments, the energy storage structure may include any combination of aluminum (Al), magnesium (Mg), silver (Ag), zinc (Zn), antimony (Sb), bismuth (Bi), and/or lead (Pb).

In some embodiments, the reinforcing structure 1004 may include a combination of the element of the energy storage structure 1002 and nickel (Ni), copper (Cu), iron (Fe), aluminum (Al), magnesium (Mg), manganese (Mn), cobalt (Co), molybdenum (Mo), zirconium (Zr), vanadium (V), titanium (Ti), chromium (Cr), bismuth (Bi), antimony (Sb), germanium (Ge), boron (B), phosphorus (P), carbon (C), sulfur (S), nitrogen (N), and/or oxygen (O).

In some embodiments, the reinforcing structure may exhibit at least some level of energy storage capacity, such as between 0 and a value less than the energy storage phase. The energy storage capacity of the reinforcing structure 1004 may be less than the energy storage capacity of the energy storage structure 1002. The element(s) included in the energy storage structure 1002 and the reinforcing structure 1004 may be chosen to include two or more elements that phase separate into two or more phases via, e.g., eutectic or eutectoid reactions. The two or more phases may be stable phases and/or equilibrium metastable phases.

An example phase separating system includes the Ni—Si system which depending on the stoichiometry and cooling rates produces multiphase composite structures of compounds of Ni and Si such as NiSi, NiSi₂, Ni₂Si, and Si. Another example phase separating system is the Cu—Si system, which produces multiphase composite structures of compounds of Cu and Si such as Cu₁₉Si₆, Cu₁₅Si₄, Cu₃₃Si₇, Cu₉Si₂, and Si. Another example phase separating system includes the Fe—Si system, which produces multiphase composite structures of compounds of Fe and Si such as FeSi₂, FeSi, and Si. In some embodiments, the phase separating system may include a combination of Ni, Cu, and/or Fe and Si. At least one of the phases created through the phase separation is the energy storage structure 1002 and at least one of the phases is the reinforcing structure 1004.

In one example, the powder comprises X of a Ni and 1-X (or 100%-X) of a Si, where X is between 15% and 44% (or between about 15% and about 44%). In some implementations, X may also be between close to 0% and 40% (or about 0% and about 40%) or between 10% and 33% (or between about 10% and about 33%). In another example, the powder includes Y of Cu and 1-Y (or 100%-Y) of Si, where Y is between close to 0% and 76% (or about 0% and about 76%) or between 10% and 68% (or between about 10% and about 68%). In another example, the powder includes Z of Fe and 1-Z (or 100%-Z) of Si, where Z is between 0% and 44% (or between about 0% and about 44%) or between 10% and 30% (or between about 10% and about 30%). In some embodiments, the percentage of Si may be low (e.g. just above 25% or just above about 25%) while still maintaining an energy storage structure. In these embodiments, non-equilibrium structures or amorphous phases are produced which may be the energy storage structure. The non-equilibrium phases can be energy storage, reinforcing, or both.

When the powder is used in an anode of a lithium ion (Li-ion) battery, the energy storage structure 1002 provides the lithium (Li) storage within the anode of Li-ion battery. However, as described previously, volume cycling within the Li-ion battery causes strain upon the anode structure. In order to stabilize the lithium ion battery, including a composite structure, which comprises both the energy storage structure 1002 and the reinforcing structure 1004, provides strain tolerance because the reinforcing structure 1004 may effectively absorb strain and thus extend the cycle life of the powder. Without being limited by a particular theory, the reinforcing structure 1004 can be, though is not required to be, ductile and thus is mechanically stable as the energy storage structure 1002. The reinforcing structure 1004 and the energy storage structure 1002 are intimately mixed on a micron or submicron scale, and thus the energy storage structure 1002 is supported and strengthened by the reinforcing structure 1004. As illustrated, the energy storage structure 1002 and the reinforcing structure 1004 are bonded together. The bonding may be both chemical and/or physical bonding and may be primarily chemical bonding.

Both the strength and rigidity of the energy storage structure 1002 and the reinforcement phase 1004 may be increased based on the strength of the bond between the structures. The ability to effectively absorb strain and extend the cycle life of the powder material will be based on the size scale of both the energy storage structure 1002 and the reinforcing structure 1004. A finer microstructure can yield a higher ability to absorb strain and thus an extended cycle life. In some embodiments, the microstructure may be less than 1 μm (or less than about 1 μm) in size, less than 500 nm (or less than about 500 nm) in size, or less than 100 nm (or less than about 100 nm) in size.

A finer microstructure, especially in the energy storage structure 1002, can inhibit the formation of phases that generate mechanical stress due to volume expansion during operation of the device. For example, when used in a Li-ion battery and the energy storage structure 1002 includes Si, Li and Si may combine to create Li₁₅Si₄, which generates mechanical stress due to large volume expansion. A composite structure with a finer microstructure may inhibit the creation of Li₁₅Si₄ by resisting the volume expansion. The overall microstructure and the size scale of the energy storage structure 1002 and the reinforcing structure 1004 may be tailored based on the cooling rate of the particles after processing. In some embodiments, the cooling rate may be greater than 1000° C. per second (or greater than about 1000° C. per second), though the particular cooling rate is not limiting.

Further, a small particle size of the powder may provide improved strength which makes the powder more damage tolerant without losing structural integrity by halting crack propagation, and can, at least in part, reduce a three dimensional strain to effectively a two dimensional strain or a one dimensional strain. Reduction of the dimensions of strain, leads to increased damage tolerance. A small particle size of the powder also distributes the expansion and/or contraction stresses over the reinforcement structure 1004 at a finer scale (e.g. micron, nanometer scale) and thus better distributes the stresses over the entire reinforcement structure 1004.

In some embodiments, the reinforcing structure 1004 may be conductive or semi-conductive to provide low resistance path for electrons to enter and leave the structure which may lead to the use of less conductive additives within the battery structure. Further, when the reinforcing structure 1004 is conductive or semi-conductive, the voltage drop across the width of the particles of the powder decreases. When the powder is used in a battery, this creates lower impedance, improved rate capability, and lower variation in state of charge within the particles of the powder.

The conductivity of the reinforcing structure 1004 may mitigate a poorly conductive energy storage structure 1002. The reinforcing structure 1004 may be an ionic conductor. The reinforcing structure 1004 may be a high strength structural member to prevent particle breakup due to the large expansion of the energy storage structure 1002. The reinforcing structure 1004 may provide resistance to the expansion of the particles during energy storage. The reinforcing structure 1004 may be a diluent structure, which may reduce the overall expansion of the particle in a controlled way. In some embodiments, the amount of energy storage structure 1002 and the reinforcing structure 1004 may be tuned in order to tradeoff between battery capacity and extended cycle life. In some embodiments, a lower amount of energy storage structure 1002 lowers the amount of expansion and contraction due to the lower energy storage, which may aid in extending cycle life of the powder.

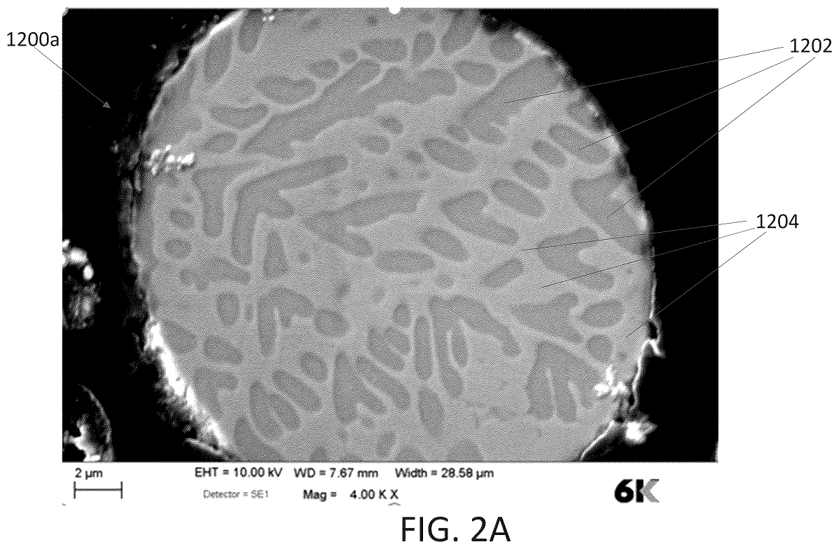

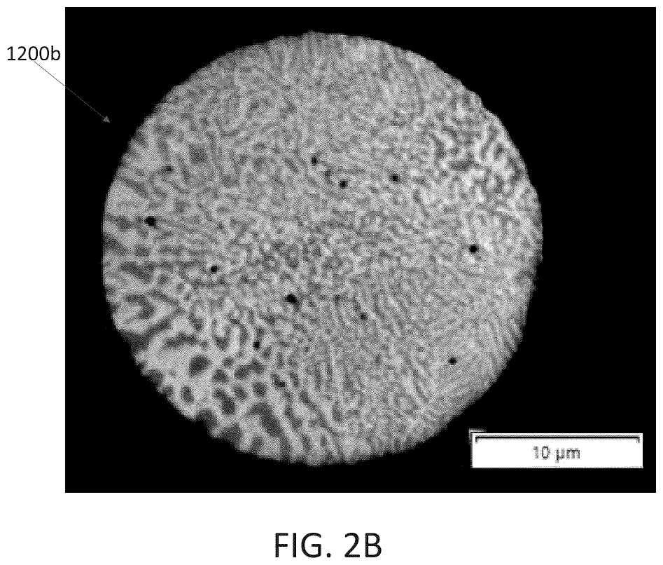

FIG. 2A is an SEM image of an exemplary strain tolerant particle 1200a composed of a eutectic or eutectoid composition of silicon and nickel. The particle 1200a includes a silicon mole fraction of 0.56 (or about 0.56) and a nickel mole fraction of 0.44 (or about 0.44). The particle 1200a includes a composite structure including a plurality of NiSi regions 1204 and a plurality of NiSi₂ regions 1202. The NiSi regions 1204 make up the energy storage structure and the NiSi₂ regions 1202 make up the reinforcing structure.

FIG. 2B is an SEM image of an exemplary strain tolerant particle 1200b composed of a eutectic or eutectoid composition of silicon and nickel. The particle 1200b includes a silicon mole fraction of 0.56 (or about 0.56) and a nickel mole fraction of 0.44 (or about 0.44). The particle 1200b includes a composite structure including a plurality of NiSi regions and a plurality of NiSi₂ regions. The darker regions are the NiSi₂ regions and the lighter regions are the NiSi regions. The NiSi regions may make up the energy storage structure and the NiSi₂ regions may make up the reinforcing structure.

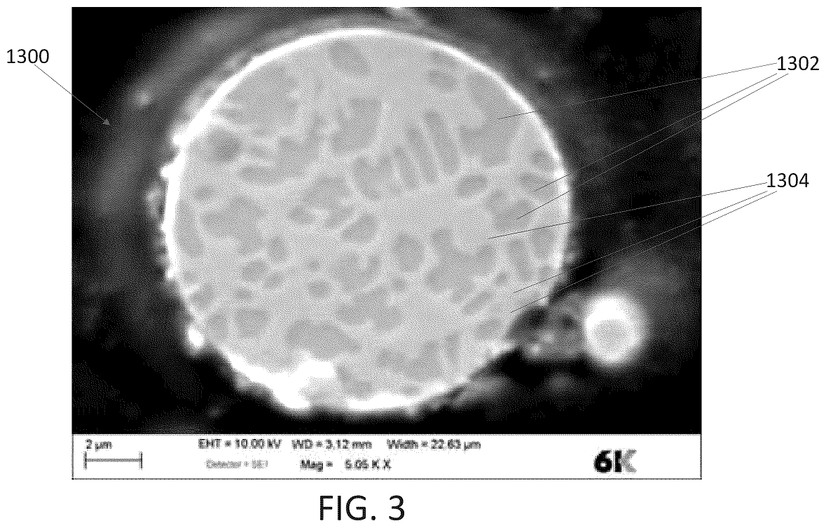

FIG. 3 is an SEM image of an exemplary strain tolerant particle 1300 composed of a hypereutectic composition of silicon and copper. The particle 1300 includes a silicon mole fraction of 0.68 (or about 0.68) and a copper mole fraction of 0.32 (or about 0.32). The particle 1300 includes a composite structure including a plurality of primary Si regions 1302 and a plurality of eutectic structured regions comprised of Si and a Cu—Si intermetallic compound 1304. The intermetallic compound may be comprised of Cu₁₉Si₆.

In some embodiments, there can be regions of “primary” Si that come out of the melt first, and then when the material cools below the bottom of the melt region, the remaining liquid will convert to a eutectic structure composed of regions of Si and of Cu₁₉Si₆.

The Si regions 1304 may make up the energy storage structure and the Cu₁₉Si₆ regions 1302 may make up the reinforcing structure.

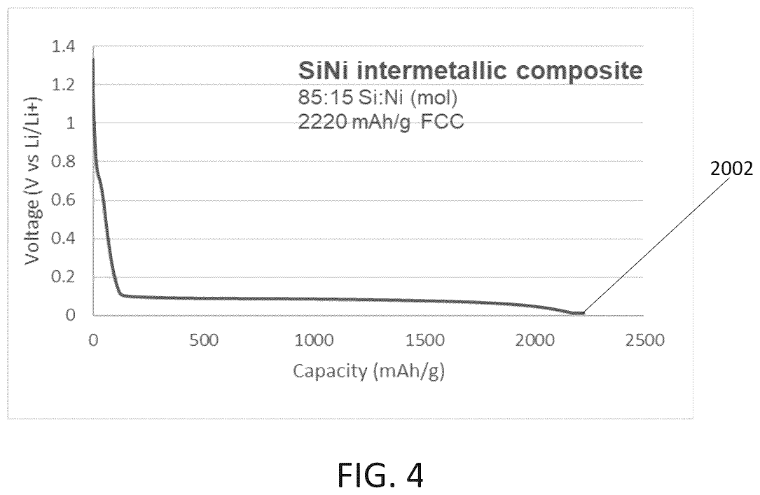

FIG. 4 is a chart demonstrating capacity vs. voltage of an example battery using strain tolerant particles including Si and Ni. In this example, the particles contain 85 (or about 85) mole percentage Si and 15 (or about 15) mole percentage Ni. As illustrated, the vertical axis illustrates voltage (V vs Li/Li+, voltage vs. lithium) and the horizontal axis illustrates capacity. The chart illustrates a first charge capacity 2002 of over 2220 mAh/g (or over about 2220 mAh/g). As illustrated, the capacity decreases as the voltage increases with a shape decline at around 0.1 V. In some embodiments, a battery made using strain tolerant particles including Si and Ni may be 500 mAh/g to 3600 mAh/g (or about 500 mAh/g to about 3600 mAh/g) or 1000 mAh/g to 3000 mAh/g (or about 1000 mAh/g to about 3000 mAh/g).

### Feedstocks

Disclosed herein are feedstock materials, or classes of feedstock materials, which can be used to manufacture particles containing in-situ formed composite alloy structures, which may be used as strain-tolerant high energy storage material structures. The structures can be in powder form, applicable in particular to anode chemistries that undergo large cyclic volume changes during charge and discharge, e.g. Si-based alloys, SiO, and Sn-based alloys. As mentioned, the strain tolerant powders can be composed of alternating energy storage structures and reinforcing structures. The energy storage structures may be used as the primary energy storage structure, which is capable of storing lithium ion particles when the particles are used in an anode of a lithium ion battery.

An example feedstock to produce the above mentioned particles is a finely divided feedstock with a predetermined ratio of constitute elements. In some embodiments, the feedstock may be produced through spray drying a mixture with the predetermined ratio of constitute elements. In this embodiment, a mixture of the predetermined ratio of constitute elements is produced. This mixture may or may not contain a binder. The binder may be polyacrylic acid, polyvinyl acetate, carboxymethylcellulose, styrene-butadiene rubber latex, polyvinyl alcohol, polyethylene glycol, starches, and/or other suitable binders. The mixture may be sprayed into a heated column of gas to remove a carrier solvent to produce a granular feedstock of the correct average composition. This process may be referred to as spray drying. The granular feedstock may be fine particulate material with a small particle size. In some embodiments, the spray dried feedstock may have particle sizes of less than 100 μm (or less than about 100 μm), less than 25 μm (or less than about 25 μm), or less than 10 μm (or less than about 10 μm), or less than 5 μm (or less than about 5 μm).

In some embodiments, the finely divided feedstock may be made by milling or grinding bulk material or coarse powder to produce a generally uniform powder. The generally uniform powder may be fine particulate material with a small particle size. The generally uniform powder may have a particle size of less than 100 μm (or less than about 100 μm), less than 25 μm (or less than about 25 μm), or less than 10 μm (or less than about 10 μm), or less than 5 μm (or less than about 5 μm). In this embodiment, the bulk material or coarse powders may contain the predetermined ratio of constituent elements. This bulk material or coarse powder is then milled to produce a finely divided feedstock. In some embodiments, separate bulk material or coarse powder composed of the target constituent elements may be milled or ground to produce fine powder of multiple components, and the resulting finely divided feedstocks may be combined in the appropriate ratios and spray dried, mechanically alloyed, or otherwise combined to create the uniform powder with the proper predetermined ratio of constituent elements. The mechanical alloying may be done by mechanically milling such as ball milling.

In some embodiments, the finely divided feedstock may be made by coating one or more constituent elements onto a core. The coating may be performed by electrodeposition, though the coating method is not limiting. In this embodiment, the core is provided which includes one of the predetermined elements. A coating process is performed on the core, which coats the core with one or more constituent elements such that the coated core includes the predetermined ratio of constitute elements. The coated core makes up the finely divided feedstock. Thus, the coating and core can melt and uniformly mix in some embodiments.

The predetermined ratio of constituent elements includes an energy storage material such as Si, Sn, Mg, Ag, Zn, Al, Pb, Sb, Bi, and their alloys and/or compounds and one or more additional alloying elements. The alloying elements may be chosen such that upon cooling from the melt, the energy storage material and the one or more alloying elements form a system capable of phase separating via a eutectic or eutectoid reaction into one or more energy storage phases and one or more reinforcing phases, which form a composite structure. The alloying elements to produce the advantageous composite structure include, but are not limited to, Ni, Cu, Fe, Al, Mg, Co, Mo, Zn, Zr, V, Ti, Cr, Bi, Sb, Ge, B, P, C, S, N, and O. The specific percentages of elements may be selected such as to provide a eutectic or eutectoid phase separation. An energy storage material and more than one alloying element may be used in order to produce more complex structures with additional phases and/or reinforcements.

A specific example includes a Si—Cu eutectic system, where Si is the energy storage material and Cu is the alloying element to create a two phase eutectic structure including Si as the energy storage structure and Cu₁₉Si₆ as the reinforcement structure. In a Si—Cu system, an equilibrium two-phase region including Si and Cu₁₉Si₆ exists when Si composes between 0.24 and 1.0 (or between about 0.24 and about 1.0) atomic fraction of the composition, with the eutectic composition when Si composes 0.32 (or about 0.32) atomic fraction of the composition. The only molecular structures that exist at equilibrium when Si composes between 0.32 and 1 (or between about 0.32 and about 1.0) atomic fraction of the composition is Si and Cu₁₉Si₆.

A hypoeutectic composition occurs when the Si composes between 0.24 and 0.32 (or between about 0.24 and about 0.32) atomic fraction of the composition. In a hypoeutectic composition, the molecular structures that exist are the eutectic Si/Cu₁₆Si₆ structure and excess Cu₁₉Si₆ structure. A eutectic composition occurs when the Si composes about 0.32 (or about 0.32) atomic fraction of the composition. In a eutectic composition, only the eutectic Si/Cu₁₉Si₆ structure will be present. A hypereutectic composition occurs at when Si composes between 0.32 and 1.0 (or between about 0.32 and about 1.0) atomic fraction of the composition which includes the eutectic Si/Cu₁₉Si₆ structure plus excess Si structure. The size of the excess Si structure is determined by the composition and the cooling rate. Thus, in a Si—Cu system, a mole fraction at 0.32 (or about 0.32) or higher of Si will create a eutectic phase separation when the feedstock is melted and then reformed that contains a eutectic structure of Si/Cu₁₉Si₆ and excess Si existing as primary grains distributed in the eutectic structure.

In some embodiments, the feedstock includes x mole fraction of Si and 1-x mole fraction of Cu, where x is above 0.24 (or above about 0.24) or above 0.32 (or above about 0.32). In some embodiments, x may be 0.4 to 0.95 (or about 0.4 to about 0.95) or 0.5 to 0.9 (or about 0.5 to about 0.9). The higher the mole fraction of Si the more energy storage capacity but the less reinforcing structure is present. The reinforcing structure prevents volume expansion and contraction during cycling and thus a greater amount of reinforcing phase leads to a higher cycle life.

In some embodiments, the weight percentage of Si may be greater than 12% (or greater than about 12%) which is equivalent to greater than 0.24 (or greater than about 0.24) atomic or mole fraction. In some embodiments, the weight percentage of Si may be greater than 17%, (or greater than about 17%) which is equivalent to greater than 0.32 (or greater than about 0.32) atomic or mole fraction. In some embodiments, the weight percentage of Si may be greater than 23% (or greater than about 23%) which is equivalent to greater than 0.4 (or greater than about 0.4) atomic or mole fraction. In some embodiments, the weight percentage of Si may be greater than 31% (or greater than about 31%) which is equivalent to greater than 0.5 (or greater than about 0.5) atomic or mole fraction. In some embodiments, the weight percentage of Si may be greater than 80% (or greater than about 80%) which is equivalent to greater than 0.9 (or greater than about 0.9) atomic or mole fraction. In some embodiments, the weight percentage of Si may be greater than 89% (or greater than about 89%) which is equivalent to greater than 0.95 (or greater than about 0.95) atomic or mole fraction.

Another specific example includes a Si—Ni system, with Si as the energy storage material and Ni as the alloying element to create a Si—Ni intermetallic reinforcement structure. In a Si—Ni system, a eutectic composition exists at 56 (or about 56) atomic or mole percent Si. At compositions where Si is between 50 and 67 (or between about 50 and about 67) atomic or mole percent, at equilibrium, a eutectic microstructure composed of NiSi and NiSi₂ occurs. At a higher cooling rate, non-equilibrium Si exists where Si is above 60 (or above about 60) atomic percent which may be due to kinetic limitations in the solid state.

When Si is above 67 (or above about 67) atomic percent, a composite structure occurs which at equilibrium is composed of a Si structure and NiSi₂ structure. The Si structure may be the energy storage structure while the NiSi₂ may be the reinforcement structure. At higher cooling rates, a NiSi structure may also be produced. In some embodiments, the feedstock includes 0.85 (or about 0.85) atomic fraction of Si and 0.15 (or about 0.15) atomic fraction of Ni.

In some embodiments, the feedstock includes y atomic fraction of Si and 1-y atomic fraction of Ni, where y is above 0.56 (or about 0.56). In some embodiments y may be 0.6 to 0.95 (or about 0.6 to about 0.95) or 0.7 to 0.9 (or about 0.7 to about 0.9). The higher the mole fraction of Si the more energy storage capacity but the less reinforcing structure is present. The reinforcing structure may limit volume expansion and contraction upon cycling. Thus, an increased amount of reinforcing structure may lead to an increased cycle life.

In some embodiments, the weight percentage of Si may be greater than 38% (or greater than about 38%) which is equivalent to greater than 0.56 (or greater than about 0.56) atomic or mole fraction. In some embodiments, the weight percentage of Si may be greater than 42% (or greater than about 42%) which is equivalent to greater than 0.6 (or greater than about 0.6) atomic or mole fraction. In some embodiments, the weight percentage of Si may be greater than 53% (or greater than about 53%) which is equivalent to greater than 0.7 (or greater than about 0.7) atomic or mole fraction. In some embodiments, the weight percentage of Si may be greater than 81% (or greater than about 81%) which is equivalent to greater than 0.9 (or greater than about 0.9) atomic or mole fraction. In some embodiments, the weight percentage of Si may be greater than 90% (or greater than about 90%) which is equivalent to greater than 0.95 (or greater than about 0.95) atomic or mole fraction.

Microwave plasma processing feedstock of the specific predetermined ratio of constituent elements may uniquely produce particles of alternating energy storage structures and reinforcing structures comprising a composite structure at the particle level. During cooling after microwave plasma processing, the specific predetermined ratio of constituent elements phase separate into a composite structure composed of energy storage structures and reinforcing structures. The characteristic size of the energy storage structures may be less than 5 μm (or less than about 5 μm), less than 1 μm (or less than about 1 μm), less than 500 nm (or less than about 500 nm), or less than 100 nm (or less than about 100 nm). It has been discovered that the unexpected result of the energy storage material and the alloying element(s) phase separating occurs via a eutectic or eutectoid reaction to form reinforced an in-situ grown composite structure.

### Final Material

The final material includes a powder with an in-situ formed composite structure including alternating energy storage structures and reinforcing structures. In some embodiments, at least one of the energy storage structure or reinforcing structure may be rod or plate shaped. In some embodiments, at least one of the energy storage structure or the reinforcing structure may be interpenetrating crystalline or amorphous phases. In some embodiments, the energy storage structures and the reinforcing structures alternate amongst one another.

The reinforcing structure functions primarily as a high strength structural member to prevent particle breakup due to the large expansion of the storage structure when storing energy. As discussed previously, during full lithiation, the anode of a lithium ion battery may experience up to a 300% (or up to about a 300%) increase in volume which places large strain on the particle which can cause the particle to breakup. By preventing particle breakup, the reinforcing structure of the composite microstructure may extend cycle life of the lithium ion battery in order to satisfy the long felt, unsolved need of extended cycle life of the lithium ion battery using this class of high-energy anode materials. The reinforcing structure of the composite microstructures may further provide resistance to the expansion. The reinforcing structure may serve as a diluent structure, which may control the overall expansion of the particle, e.g. reduce the overall expansion of the particle. The reinforcing structure replaces energy storage structure that would otherwise be present and thus helps manage expansion.

Further, the reinforcing structure may limit the amount the energy storage structure can expand when the size scale of the energy storage structure and reinforcing structures are small. The reinforcing structure may also provide resistance to the strain of expansion by limiting the overall strain the particles experience. The reinforcing structure may further serve as an electronic conductor to provide a low resistance path for electrons to enter and leave the structure. The energy storage structure by itself may be a poor conductor and thus the reinforcing structure may provide a low resistance path for electrons into and out of the particle during charge and discharge. Without a low resistance path, voltage drops will be high and resistance will be large which may limit the ability of the particles to conduct. The reinforcing structure may be an ionic conductor. The reinforcing structure may also have energy storage properties.

The ability to effectively absorb strain and thus extend the cycle life of the particles with the energy storage structure and the reinforcing structure will be related to the size and scale of both the energy storage structure and the reinforcing structure, the strength and rigidity of the energy storage structure and the reinforcing structure, the morphology of the composite structure, the relative fractions of the energy storage structure and the reinforcing structure, and the strength of the bond between the energy storage structure and the reinforcing structure. In some embodiments, the morphology of the composite structure may be plates, rods, or spherical precipitates.

Further, using a high cooling rate after plasma processing produces fine size scales in the composite structure. A finer size scale of composite structures maximizes the resistance to mechanical damage. In some embodiments, the cooling rate may be greater than 1000° C. (or greater than about 1000° C.) per second, greater than 900° C. (or greater than about 900° C.) per second, greater than 800° C. (or greater than about 800° C.) per second, or greater than 700° C. (or greater than about 700° C.) per second. Further a high cooling rate may allow for the retention of non-equilibrium phases which can result in a greater fraction of energy storage structures than would be present with just equilibrium phases. In some embodiments, upon further cooling, the material may go through two or more phase separation regions (e.g. second or third phase separation regions) when single phase solid solutions drop below their solubility limit and further phase separate. In some embodiments, the material may be cooled to retain non-equilibrium structures. In some embodiments, additional heating may be performed to induce phase separations. The further phase separation may create desirable fine feature sizes.

In some embodiments, the particles can have size in a range of 0.5 μm to 100 μm (or about 0.5 μm to about 100 μm). In some embodiments, the particles can have a size of 20 μm (or about 20 μm) or less. Further, the particles can have a size of 10 μm to 40 μm (or about 10 μm to about 40 μm), 15 μm to 30 μm (or about 15 μm to about 30 μm), or 17 μm to 25 μm (or about 17 μm to about 25 μm). In some embodiments, the particles may have a size of 1 μm to 5 μm (or about 1 μm to about 5 μm) or 0.5 μm to 10 μm (or about 0.5 μm to about 10 μm). The size of the particles may be determined by the size of the feedstock which is plasma processed. Further, the ratios of elements within the starting feedstock may determine the ratios of elements within the particles. Thus, by using a feedstock with 0.85 (or about 0.85) mole fraction of silicon and 0.15 (or about 0.15) mole fraction of nickel, the mole fraction of the resulting particle may be substantially 0.85 (or about 0.85) mole fraction of silicon and 0.15 (or about 0.15) mole fraction of nickel.

In some embodiments, the energy storage structure may comprise 80% (or about 80%) of the particle while the reinforcing structure may comprise 20% (or about 20%) of the particle. In some embodiments, the energy storage structure has a weight percentage of greater than 5% (or greater than about 5%) or greater than 10% (or greater than about 10%) of the particle. In some embodiments, the energy storage structure has a weight percentage of 20% to 80% (or about 20% to about 80%) or 30% to 60% (or about 30% to about 60%) or 20% to 95% (or about 20% to about 95%) of the particle.

### Sphericity

In some embodiments, the final particles achieved by processing can be spherical or spheroidal, terms which can be used interchangeably.

Embodiments of the present disclosure are directed to producing particles that are substantially spherical or spheroidal or have undergone significant spheroidization. In some embodiments, spherical, spheroidal or spheroidized particles refer to particles having a sphericity greater than a certain threshold. Particle sphericity can be calculated by calculating the surface area of a sphere A_{s,ideal} with a volume matching that of the particle, V using the following equation:

$$r \text{?} = \sqrt[*]{\frac{3 V}{4 π}}$$

$$A \text{?} = \text{?}$$

$$\text{?} \text{indicates text missing or illegible when filed}$$

and then comparing that idealized surface area with the measured surface area of the particle, A_{s,actual}:

$$Sphericity = \frac{{A}_{s , ideal}}{{A}_{s , actual}} .$$

In some embodiments, particles can have a sphericity of greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, particles can have a sphericity of 0.75 or greater or 0.91 or greater (or about 0.75 or greater or about 0.91 or greater). In some embodiments, particles can have a sphericity of less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a particle is considered to be spherical, spheroidal or spheroidized if it has a sphericity at or above any of the aforementioned sphericity values, and in some preferred embodiments, a particle is considered to be spherical if its sphericity is at or about 0.75 or greater or at or about 0.91 or greater.

In some embodiments, a median sphericity of all particles within a given powder can be greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, a median sphericity of all particles within a given powder can be less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a powder is considered to be spheroidized if all or a threshold percentage (as described by any of the fractions below) of the particles measured for the given powder have a median sphericity greater than or equal to any of the aforementioned sphericity values, and in some preferred embodiments, a powder is considered to be spheroidized if all or a threshold percentage of the particles have a median sphericity at or about 0.75 or greater or at or about 0.91 or greater.

In some embodiments, the fraction of particles within a powder that can be above a given sphericity threshold, such as described above, can be greater than 50%, 60%, 70%, 80%, 90%, 95%, or 99% (or greater than about 50%, about 60%, about 70%, about 80%, about 90%, about 95%, or about 99%). In some embodiments, the fraction of particles within a powder that can be above a given sphericity threshold, such as described above, can be less than 50%, 60%, 70%, 80%, 90%, 95%, or 99% (or less than about 50%, about 60%, about 70%, about 80%, about 90%, about 95%, or about 99%).

Particle size distribution and sphericity may be determined by any suitable known technique such as by SEM, optical microscopy, dynamic light scattering, laser diffraction, manual measurement of dimensions using an image analysis software, for example from about 15-30 μmeasures per image over at least three images of the same material section or sample, and any other techniques.

Embodiments of the disclosed process can include feeding the powders using a powder feeder into a microwave generated plasma where the power density, gas flows and residence time are controlled. The process parameters such as power density, flow rates and residence time of the powder in the plasma can depend on the powder material's physical characteristics, such as the melting point and thermal conductivity. The power density can range from 20 W/cm³ to 500 W/cm³ (or about 20 W/cm³ to about 500 W/cm³). The total gas flows can range from 0.1 cfm to 50 cfm (or about 0.1 cfm to about 50 cfm), and the residence time can be tuned from 1 ms to 10 sec (or about 1 ms to about 10 sec). This range of process parameters will cover the required processing parameters for materials with a wide range of melting point and thermal conductivity.

Different environmental gasses can be used for different applications.

### Plasma Processing

The above disclosed particles/structures/powders/precursors can be used in a number of different processing procedures. For example, spray/flame pyrolysis, radiofrequency plasma processing, and high temperature spray driers can all be used. The following disclosure is with respect to microwave plasma processing, but the disclosure is not so limiting.

In some cases, the feedstock may include a well-mixed slurry containing the constituent solid materials suspended in a liquid carrier medium which can be fed through a droplet making device. Some embodiments of the droplet making device include a nebulizer and atomizer. The droplet maker can produce solution precursor droplets with diameters ranging approximately 1 um-200 um. The droplets can be fed into the microwave plasma torch, a plasma plume of the microwave plasma torch, and/or an exhaust of the microwave plasma torch. As each droplet is heated within a plasma hot zone created by the microwave plasma torch, the carrier liquid is driven off and the remaining dry components melt to form a molten droplet containing the constituent elements. The plasma gas can be argon, nitrogen, helium hydrogen or a mixture thereof.

In some embodiments, the droplet making device can sit to the side of the microwave plasma torch. The feedstock material can be fed by the droplet making device from the side of the microwave plasma torch. The droplets can be fed from any direction into the microwave generated plasma.

Amorphous material can be produced after the precursor is processed into the desired material and is then cooled at a rate sufficient to prevent atoms to reach a crystalline state. The cooling rate can be achieved by quenching the material within 0.05-2 seconds of processing in a high velocity gas stream. The high velocity gas stream temperature can be in the range of −200° C.-40° C.

Alternatively, crystalline material can be produced when the plasma length and reactor temperature are sufficient to provide particles with the time and temperature necessary for atoms to diffuse to their thermodynamically favored crystallographic positions. The length of the plasma and reactor temperature can be tuned with parameters such as power (2-120 kW), torch diameter (0.5-4″), reactor length (0.5-30′), gas flow rates (1-20 CFM), gas flow characteristics (laminar or turbulent), and torch type (laminar or turbulent). Longer time at the right temperature results in more crystallinity.

The process parameters can be optimized to obtain maximum spheroidization depending on the feedstock initial condition. For each feedstock characteristic, process parameters can be optimized for a particular outcome. U.S. Pat. Pub. No. 2018/0297122, U.S. Pat. Nos. 8,748,785 B2, and 9,932,673 B2 disclose certain processing techniques that can be used in the disclosed process, specifically for microwave plasma processing. Accordingly, U.S. Pat. Pub. No. 2018/0297122, U.S. Pat. Nos. 8,748,785 B2, and 9,932,673 B2 are incorporated by reference in its entirety and the techniques describes should be considered to be applicable to the feedstock described herein.

One aspect of the present disclosure involves a process of spheroidization using a microwave generated plasma. The powder feedstock is entrained in a gas environment and injected into the microwave plasma environment. Upon injection into a hot plasma (or plasma plume or exhaust), the feedstock is spheroidized and released into a chamber filled with a gas and directed into drums where is it stored. This process can be carried out at atmospheric pressure, in a partial vacuum, or at a higher pressure than atmospheric pressure. In alternative embodiments, the process can be carried out in a low, medium, or high vacuum environment. The process can run continuously and the drums are replaced as they fill up with spheroidized particles.

Advantageously, varying cooling processing parameters has been found to alter the characteristic microstructure of the end particles. A higher cooling rate results in a finer structure. Non-equilibrium structure may be achieved via high cooling rates.

Cooling processing parameters include, but are not limited to, cooling gas flow rate, residence time of the spheroidized particles in the hot zone, and the composition or make of the cooling gas. For example, the cooling rate or quenching rate of the particles can be increased by increasing the rate of flow of the cooling gas. The faster the cooling gas is flowed past the spheroidized particles exiting the plasma, the higher the quenching rate-thereby allowing certain desired microstructures to be locked-in. Residence time of the particles within the hot zone of the plasma can also be adjusted to provide control over the resulting microstructure. Residence time can be adjusted by adjusting such operating variables as particle injection rate and flow rate (and conditions, such as laminar flow or turbulent flow) within the hot zone. Equipment changes can also be used to adjust residence time. For example, residence time can be adjusted by changing the cross-sectional area of the hot zone.

Another cooling processing parameter that can be varied or controlled is the composition of the cooling gas. Certain cooling gases are more thermally conductive than others. For example helium is considered to be a highly thermally conductive gas. The higher the thermal conductivity of the cooling gas, the faster the spheroidized particles can be cooled/quenched. By controlling the composition of the cooling gas (e.g., controlling the quantity or ratio of high thermally conductive gasses to lesser thermally conductive gases) the cooling rate can be controlled.

In one exemplary embodiment, inert gas is continually purged to remove oxygen within a powder-feed hopper. A continuous volume of powder feed is then entrained within an inert gas and fed into the microwave generated plasma to prevent excessive oxidation of the material. In one example, the microwave generated plasma may be generated using a microwave plasma torch, as described in U.S. Pat. Nos. 8,748,785, 9,023,259, 9,206,085, 9,242,224, and 10,477,665 each of which is hereby incorporated by reference in its entirety.

In some embodiments, the particles are exposed to a uniform (or non-uniform) temperature profile at between 4,000 and 8,000 K within the microwave generated plasma. In some embodiments, the particles are exposed to a uniform temperature profile at between 3,000 and 8,000 K within the microwave generated plasma. Within the plasma torch, the powder particles are rapidly heated and melted. As the particles within the process are entrained within a gas, such as argon, generally contact between particles is minimal, greatly reducing the occurrence of particle agglomeration. The need for post-process sifting is thus greatly reduced or eliminated, and the resulting particle size distribution could be practically the same as the particle size distribution of the input feed materials. In exemplary embodiments, the particle size distribution of the feed materials is maintained in the end products.

Within the plasma, plasma plume, or exhaust, the melted materials are inherently spheroidized due to liquid surface tension. As the microwave generated plasma exhibits a substantially uniform temperature profile, more than 90% spheroidization of particles could be achieved (e.g., 91%, 93%, 95%, 97%, 99%, 100%). After exiting the plasma, the particles are cooled before entering collection bins. When the collection bins fill, they can be removed and replaced with an empty bin as needed without stopping the process.

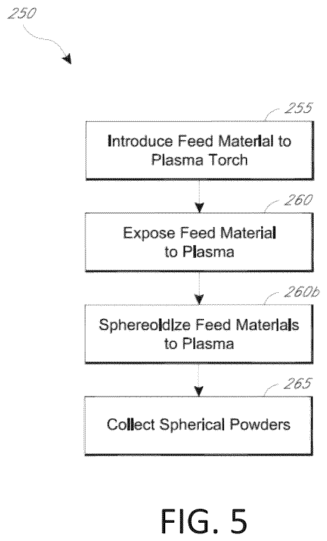

FIG. 5 is a flow chart illustrating an exemplary method (250) for producing spherical powders, according to an embodiment of the present disclosure. In this embodiment, the process (250) begins by introducing a feed material into a plasma torch (255). In some embodiments, the plasma torch is a microwave generated plasma torch or an RF plasma torch. Within the plasma torch, the feed materials are exposed to a plasma causing the materials to melt, as described above (260). The melted materials are spheroidized by surface tension, as discussed above (260b). After exiting the plasma, the products cool and solidify, locking in the spherical shape and are then collected (265).

In some embodiments, the environment and/or sealing requirements of the bins are carefully controlled. That is, to prevent contamination or potential oxidation of the powders, the environment and or seals of the bins are tailored to the application. In one embodiment, the bins are under a vacuum. In one embodiment, the bins are hermetically sealed after being filled with powder generated in accordance with the present technology. In one embodiment, the bins are back filled with an inert gas, such as, for example argon. Because of the continuous nature of the process, once a bin is filled, it can be removed and replaced with an empty bin as needed without stopping the plasma process.

The methods and processes in accordance with the disclosure can be used to make powders, such as spherical powders.

In some embodiments, the processing discussed herein, such as the microwave plasma processing, can be controlled to prevent and/or minimize certain elements from escaping the feedstock during the melt, which can maintain the desired composition/microstructure.

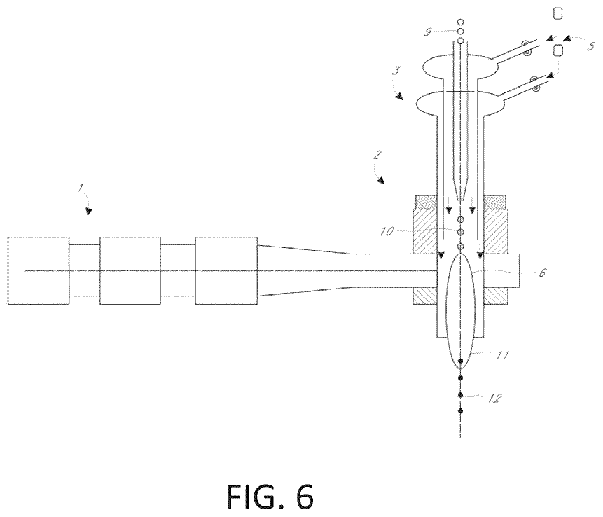

FIG. 6 illustrates an exemplary microwave plasma torch that can be used in the production of powders, according to embodiments of the present disclosure. As discussed above, feed materials 9, 10 can be introduced into a microwave plasma torch 3, which sustains a microwave generated plasma 11. In one example embodiment, an entrainment gas flow and a sheath flow (downward arrows) may be injected through inlets 5 to create flow conditions within the plasma torch prior to ignition of the plasma 11 via microwave radiation source 1.

In some embodiments, the entrainment flow and sheath flow are both axis-symmetric and laminar, while in other embodiments the gas flows are swirling. The feed materials 9 are introduced axially into the microwave plasma torch, where they are entrained by a gas flow that directs the materials toward the plasma. Within the microwave generated plasma, the feed materials are melted in order to spheroidize the materials. Inlets 5 can be used to introduce process gases to entrain and accelerate particles 9, 10 along axis 12 towards plasma 11. First, particles 9 are accelerated by entrainment using a core laminar gas flow (upper set of arrows) created through an annular gap within the plasma torch. A second laminar flow (lower set of arrows) can be created through a second annular gap to provide laminar sheathing for the inside wall of dielectric torch 3 to protect it from melting due to heat radiation from plasma 11. In exemplary embodiments, the laminar flows direct particles 9, 10 toward the plasma 11 along a path as close as possible to axis 12, exposing them to a substantially uniform temperature within the plasma.

In some embodiments, suitable flow conditions are present to keep particles 10 from reaching the inner wall of the plasma torch 3 where plasma attachment could take place. Particles 9, 10 are guided by the gas flows towards microwave plasma 11 where each undergoes homogeneous thermal treatment. Various parameters of the microwave generated plasma, as well as particle parameters, may be adjusted in order to achieve desired results. These parameters may include microwave power, feed material size, feed material insertion rate, gas flow rates, plasma temperature, residence time and cooling rates. In some embodiments, the cooling or quenching rate is not less than 10⁺³ degrees C./sec upon exiting plasma 11. As discussed above, in this particular embodiment, the gas flows are laminar; however, in alternative embodiments, swirl flows or turbulent flows may be used to direct the feed materials toward the plasma.

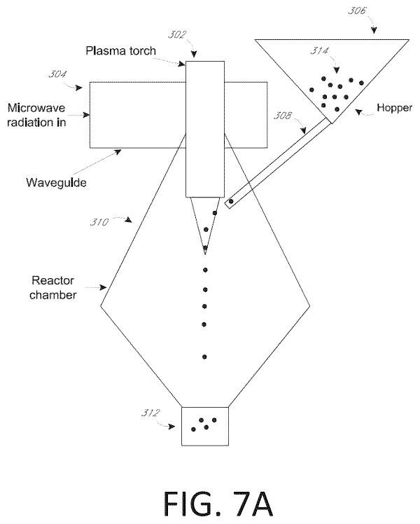

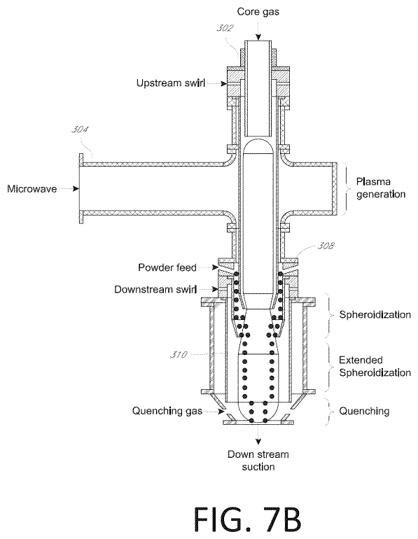

FIGS. 7A-B illustrate an exemplary microwave plasma torch that includes a side feeding hopper rather than the top feeding hopper shown in the embodiment of FIG. 6, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 6. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, or swirl torches described in U.S. Pat. Nos. 8,748,785 B2 and 9,932,673 B2. Both FIG. 7A and FIG. 7B show embodiments of a method that can be implemented with either an annular torch or a swirl torch. A feed system close-coupled with the plasma plume at the exit of the plasma torch is used to feed powder axisymmetrically to preserve process homogeneity.

Other feeding configurations may include one or several individual feeding nozzles surrounding the plasma plume. The feedstock powder can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 314 can be introduced into a microwave plasma torch 302. A hopper 306 can be used to store the feed material 314 before feeding the feed material 314 into the microwave plasma torch 302, plume, or exhaust. The feed material 314 can be injected at any angle to the longitudinal direction of the plasma torch 302. 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma torch through a waveguide 304. The feed material 314 is fed into a plasma chamber 310 and is placed into contact with the plasma generated by the plasma torch 302. When in contact with the plasma, plasma plume, or plasma exhaust, the feed material melts. While still in the plasma chamber 310, the feed material 314 cools and solidifies before being collected into a container 312. Alternatively, the feed material 314 can exit the plasma chamber 310 while still in a melted phase and cool and solidify outside the plasma chamber. In some embodiments, a quenching chamber may be used, which may or may not use positive pressure. While described separately from FIG. 6, the embodiments of FIGS. 7A-7B are understood to use similar features and conditions to the embodiment of FIG. 6.

In some embodiments, implementation of the downstream injection method may use a downstream swirl, extended spheroidization, or quenching. A downstream swirl refers to an additional swirl component that can be introduced downstream from the plasma torch to keep the powder from the walls of the tube. An extended spheroidization refers to an extended plasma chamber to give the powder longer residence time. In some implementations, it may not use a downstream swirl, extended spheroidization, or quenching. In some embodiments, it may use one of a downstream swirl, extended spheroidization, or quenching. In some embodiments, it may use two of a downstream swirl, extended spheroidization, or quenching.

Injection of powder from below may result in the reduction or elimination of plasma-tube coating in the microwave region. When the coating becomes too substantial, the microwave energy is shielded from entering the plasma hot zone and the plasma coupling is reduced. At times, the plasma may even extinguish and become unstable. Decrease of plasma intensity means decreases in spheroidization level of the powder. Thus, by feeding feedstock below the microwave region and engaging the plasma plume at the exit of the plasma torch, coating in this region is eliminated and the microwave powder to plasma coupling remains constant through the process allowing adequate spheroidization.

Thus, advantageously the downstream approach may allow for the method to run for long durations as the coating issue is reduced. Further, the downstream approach allows for the ability to inject more powder as there is no need to minimize coating.

From the foregoing description, it will be appreciated that inventive processing methods, precursors, anodes, and powders are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

The disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A particle comprising:
a composite structure including:
a eutectic, eutectoid, or hypereutectic structure comprising alternating regions of an energy storage structure and a reinforcing structure;
the energy storage structure comprising at least one element, wherein the energy storage structure is configured to store ions; and
the reinforcing structure comprising one or more elements that phase separate from the energy storage structure via a eutectic or eutectoid reaction,
wherein the reinforcing structure provides mechanical support to the energy storage structure,
wherein at least one of the energy storage structure or the reinforcing structure comprises interpenetrating crystalline or amorphous phases.

2. The particle of claim 1, wherein the energy storage structure comprises silicon and/or tin.

3. The particle of claim 1, wherein the reinforcing structure comprises nickel, copper, iron, aluminum, magnesium, manganese, cobalt, molybdenum, zirconium, vanadium, titanium, chromium, bismuth, antimony, germanium, boron, phosphorus, carbon, sulfur, nitrogen, and/or oxygen.

4. The particle of claim 1, wherein the energy storage structure comprises silicon and the reinforcing structure comprises nickel and silicon.

5. The particle of claim 4, wherein the reinforcing structure comprises NiSi₂ and NiSi.

6. The particle of claim 4, wherein the reinforcing structure comprises a higher nickel content than the nickel content of the energy storage structure.

7. The particle of claim 4, wherein the composite structure comprises a silicon mole fraction greater than or equal to about 0.56.

8. The particle of claim 4, wherein the composite structure comprises a silicon mole fraction greater than or equal to about 0.7.

9. The particle of claim 1, wherein the energy storage structure comprises silicon and the reinforcing structure comprises copper and silicon.

10. The particle of claim 9, wherein the reinforcing structure comprises Cu₁₉Si₆.

11. The particle of claim 9, wherein the reinforcing structure comprises a higher copper content than the copper content of the energy storage structure.

12. The particle of claim 9, wherein the composite structure comprises a silicon mole fraction greater than or equal to about 0.24.

13. The particle of claim 9, wherein the composite structure comprises a silicon mole fraction greater than or equal to about 0.32.

14. The particle of claim 1, wherein the composite structure comprises a plurality of energy storage structures and a plurality of reinforcing structures that bind the plurality of energy storage structures.

15. The particle of claim 1, wherein the alternating regions comprise stable phases.

16. The particle of claim 1, wherein the alternating regions comprise equilibrium metastable phases.

17. A method of manufacturing a particle comprising:
preparing a feedstock comprising divided droplets or particles with a certain ratio of constituent elements that phase separate into two or more phases by eutectic or eutectoid reaction;
introducing the feedstock into a plasma or plasma exhaust of a microwave plasma torch to melt the feedstock; and
cooling the feedstock so as to trigger a eutectic or eutectoid transition resulting in one or more phase separations which create a eutectic, eutectoid, or hypereutectic structure comprising alternating regions of an energy storage structure and a reinforcing structure that provides mechanical support to the energy storage structure,
the energy storage structure comprising at least one element, wherein the energy storage structure is configured to store ions,
the reinforcing structure comprising one or more elements that phase separate from the energy storage structure, wherein the reinforcing structure provides mechanical support to the energy storage structure,
wherein at least one of the energy storage structure or the reinforcing structure comprises interpenetrating crystalline or amorphous phases.

18. The method of manufacturing of claim 17, wherein the feedstock comprises silicon and at least one of copper, nickel, or iron.

19. The method of manufacturing of claim 18, wherein the feedstock comprises nickel and comprises a silicon mole fraction greater than or equal to about 0.7.

20. A particle comprising:
a composite structure including:
a eutectic, eutectoid, or hypereutectic structure comprising alternating regions of an energy storage phase and a reinforcing phase,
the energy storage phase comprising at least one element, wherein the energy storage phase is configured to store ions; and
the reinforcing phase comprising one or more elements, and
wherein at least one of the energy storage phase or the reinforcing phase comprises interpenetrating crystalline or amorphous phases;
wherein upon cooling the composite structure from a melt, a eutectic or eutectoid transition occurs resulting in phase separation of the composite structure into two or more distinct phases, at least one phase of which is the energy storage phase, and at least one phase of which is the reinforcing phase, resulting in an in-situ grown composite microstructure at a particle level, wherein the reinforcing phase provides mechanical support to the energy storage phase.
